(19) United States
(12) Patent Application Publication
(10) Pub. No.: US 2026/0094094 A1
(43) Pub. Date: Apr. 2, 2026

(54) AGENTIC WORKFLOW PROGRAMMING WITH SEARCH OVER EXECUTION BRANCHES

(71) Applicant: ASARI AI INC., San Francisco, CA (US)

(72) Inventors: Zhening LI, Cambridge, MA (US); Stephan Tao ZHENG, San Francisco, CA (US)

(21) Appl. No.: 19/346,151

(22) Filed: Sep. 30, 2025

Related U.S. Application Data
(60) Provisional application No. 63/702,079, filed on Oct. 1, 2024.
(60) Provisional application No. 63/751,757, filed on Jan. 30, 2025.

(51) Int. Cl. G06Q 10/0631

(52) U.S. Cl. CPC G06Q 10/06316

(57) ABSTRACT

One embodiment of the present invention sets forth a technique for executing an agentic workflow. The technique includes upon determining that a first branchpoint is reached during execution of the agentic workflow, executing, based on one or more calls received over an interface associated with the first branchpoint, a first plurality of branches from the first branchpoint and a state of the agentic workflow at the first branchpoint to one or more subsequent branchpoints within the agentic workflow. The technique also includes executing, based on a first plurality of evaluation scores associated with executing the first plurality of branches, a second plurality of branches from at least a portion of the one or more subsequent branchpoints to one or more additional points within the agentic workflow.

### CROSS-REFERENCE TO RELATED APPLICATIONS

This application claims the benefit of the U.S. Provisional Application titled “META-PROGRAMMING FOR AGENT WORKFLOWS,” filed on Oct. 1, 2024, and having Ser. No. 63/702,079, and also claims the priority benefit of the U.S. Provisional Application titled “SEARCH OVER NONDETERMINISTIC EXECUTION PATHS IN AGENTIC WORKFLOWS,” filed on Jan. 30, 2025, and having Ser. No. 63/751,757. The subject matter of these related applications is hereby incorporated

### BACKGROUND

### Field of the Various Embodiments

Embodiments of the present disclosure relate generally to artificial intelligence and agentic design and, more specifically, to agentic workflow programming with search over execution branches.

### Description of the Related Art

Artificial intelligence (AI) agents include software systems that use large language models (LLMs) and/or other machine learning techniques to complete complex multi-step workflows on behalf of users. For example, an AI agent may be capable of processing various types of data, such as (but not limited to) text, images, audio, video, and/or code; conducting a conversation with a user and/or working with other agents or software systems; and/or reasoning, planning, learning over time, recalling memories, and/or making decisions.

However, the probabilistic nature of LLMs and/or other components used in agentic workflows involving AI agents can cause the output of these agentic workflows to be unreliable and/or unpredictable. In particular, LLM generations can vary significantly across invocations involving the same inputs and/or generate incorrect and/or suboptimal results that propagate through subsequent workflow steps.

More recently, inference-time search strategies involving selecting and/or improving LLM outputs have been developed to improve performance and reliability in agentic workflows. These strategies include best-of-N sampling, in which multiple LLM outputs are generated and the best response is selected based on a reward mode and/or scoring function; self-consistency, in which multiple LLM outputs are sampled and aggregated to determine the most consistent output; refinement, in which feedback related to an initial set of LLM outputs is used to revise and/or improve subsequent LLM outputs; and/or tree search techniques that search over reasoning chains that include sequences of LLM reasoning steps.

However, conventional implementations of inference-time search strategies are typically baked into and entangled with implementations of core logic for agentic workflows. More specifically, each inference-time strategy may be implemented in a corresponding agentic workflow by applying, compiling, and running a different set of modifications to source code for the agentic workflow. This entangled code obscures the agentic workflow logic and lacks modularity, resulting in significant time and resource overhead in configuring, customizing, designing, and/or exploring different inference-time strategies for a given agentic workflow and/or propagating the same inference-time strategy to multiple agentic workflows.

Additionally, these modifications become even harder to read, scale, debug, and/or maintain as optimizations are incorporated and/or complex search strategies that involve explicitly defining search spaces for the agentic workflows are used. Thus, complex inference-time strategies tend to be limited to simple agentic workflows such as those that repeatedly sample actions from LLMs, while complex agentic workflows tend to be restricted to simple inference-time strategies such as refinement and/or resampling of individual LLM calls.

As the foregoing illustrates, what is needed in the art are more effective techniques for improving the execution of agentic workflows.

### SUMMARY

One embodiment of the present invention sets forth a technique for executing an agentic workflow. The technique includes upon determining that a first branchpoint is reached during execution of the agentic workflow, executing, based on one or more calls received over an interface associated with the first branchpoint, a first plurality of branches from the first branchpoint and a state of the agentic workflow at the first branchpoint to one or more subsequent branchpoints within the agentic workflow. The technique also includes executing, based on a first plurality of evaluation scores associated with executing the first plurality of branches, a second plurality of branches from at least a portion of the one or more subsequent branchpoints to one or more additional points within the agentic workflow.

One technical advantage of the disclosed techniques relative to the prior art is the disentanglement of (i) source code, executable code, and/or other representations of logic for the agentic workflow from (ii) corresponding representations of inference-time search strategies that can be used to improve the reliability and/or performance of the agentic workflow. The disclosed techniques thus reduce time and resource overhead associated with implementing, modifying, customizing, and/or transferring inference-time search strategies over conventional implementations of inference-time search strategies that apply, compile, and run a different set of modifications to source code for each agentic workflow. Additionally, the improved speed and efficiency with which inference-time search strategies can be explored and/or optimized may increase the reliability and/or performance of the agentic workflow over agentic workflows that are executed using conventional implementations of inference-time search strategies. Further, because the disclosed techniques allow inference-time search strategies to be defined using a basic set of statements and calls and/or without explicitly defining search spaces for agentic workflows, the disclosed techniques allow agentic workflows and inference-time search strategies of arbitrary complexity to be used with one another. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the generation engine and execution engine of FIG. 1, according to various embodiments.

FIG. 3 illustrates the compilation and execution of an example agentic workflow by the generation engine and execution engine of FIG. 1, according to various embodiments.

FIG. 4 is a flow diagram of method steps for generating and executing an agentic workflow, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

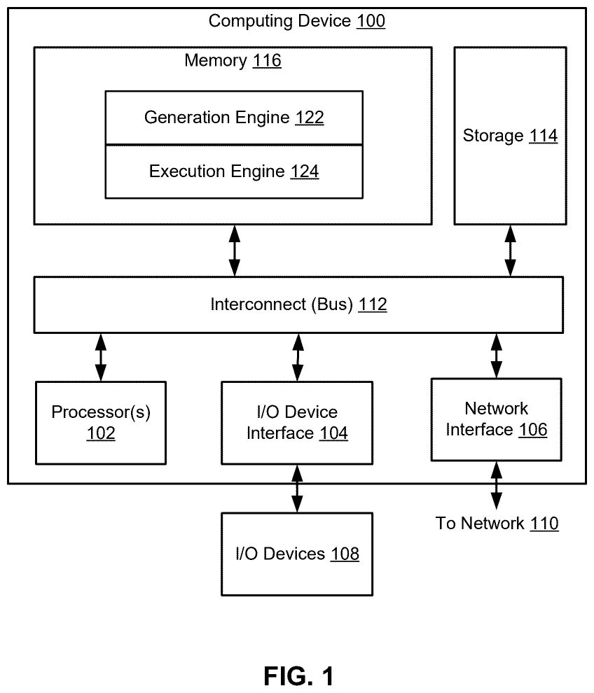

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a generation engine 122 and an execution engine 124 that reside in memory 116.

It is noted that the computing device described herein is illustrative and that any other technically feasible configurations fall within the scope of the present disclosure. For example, multiple instances of generation engine 122 and execution engine 124 could execute on a set of nodes in a distributed and/or cloud computing system to implement the functionality of computing device 100. In another example, generation engine 122 and/or execution engine 124 could execute on various sets of hardware, types of devices, or environments to adapt generation engine 122 and/or execution engine 124 to different use cases or applications. In a third example, generation engine 122 and execution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Generation engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including generation engine 122 and execution engine 124.

In one or more embodiments, generation engine 122 and execution engine 124 include functionality to perform agentic workflow programming with search over execution branches, in which a program for an agentic workflow is compiled and run in a way that separates the logic for the agentic workflow from search strategies used to improve the performance and/or reliability of the agentic workflow. The agentic workflow may involve a multi-step process that includes invocations of large language models (LLMs) and/or other machine learning components that generate output probabilistically, tool usage, reasoning changes, code generation and/or execution, and/or other operations that can lead to variable and/or unreliable outputs.

More specifically, generation engine 122 and execution engine 124 provide a probabilistic angelic nondeterminism (PAN) framework that allows source code for the agentic workflow to disentangle statements and/or calls related to an inference-time search strategy from the underlying logic of the agentic workflow. These statements and/or calls may specify branchpoints at which execution of the agentic workflow can be branched into multiple threads of execution.

During execution of the agentic workflow, each branch off of a corresponding branchpoint is executed until a subsequent branchpoint and/or another terminating point specified in the source code is reached. A state of the agentic workflow at the terminating point of each branch and/or an evaluation score associated with the branch are stored, and a search over execution paths composed of sequences of branches that span the agentic workflow is performed based on the corresponding states and/or evaluation scores. Search parameters and/or strategies used to perform the search can additionally be specified via calls over an interface provided by the framework. The process is recursively repeated for each path until the end of the program is reached. A final state and/or output of the agentic workflow may then be determined and/or outputted based on an objective associated with a “final evaluation score” and/or another attribute at the end of each path. Generation engine 122 and execution engine 124 are described in further detail below.

### Agentic Workflow Programming with Search Over Execution Branches

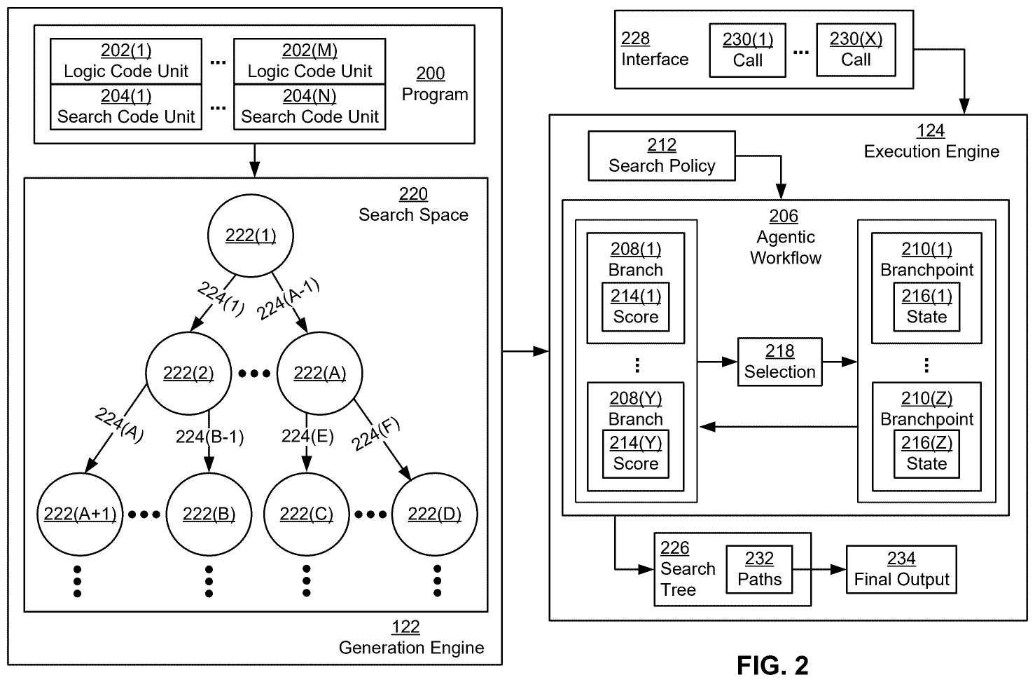

FIG. 2 is a more detailed illustration of generation engine 122 and execution engine 124 of FIG. 1, according to various embodiments. As mentioned above, generation engine 122 and execution engine 124 include functionality to perform agentic workflow programming with search over execution branches. Each of these components is described in further detail below.

Generation engine 122 generates a search space 220 associated with an agentic workflow 206 by compiling a corresponding program 200 that includes source code and/or another representation of agentic workflow 206. As shown in FIG. 2, program 200 includes a set of logic code units 202(1)-202(M) (each of which is referred to individually herein as logic code unit 202) and a separate set of search code units 204(1)-204(N) (each of which is referred to individually herein as search code unit 204).

Logic code units 202 include representations of logic for agentic workflow 206. For example, each logic code unit 202 may include a statement, expression, condition, instruction, function, method, line of code, and/or another “unit” of source code, pseudocode, and/or another way of defining the behavior of agentic workflow 206.

Search code units 204 include representations of inference-time search strategies associated with agentic workflow 206. For example, each search code unit 204 may include a statement, expression, condition, instruction, function, method, line of code, and/or another “unit” of source code, pseudocode, and/or another way of defining a strategy for executing, searching, sampling, selecting, and/or otherwise using probabilistic output generated by LLMs and/or other components in agentic workflow 206.

In one or more embodiments, search code units 204 specify one or more branchpoints 210(1)-210(Z) (each of which is referred to individually herein as branchpoint 210) within agentic workflow 206. Each branchpoint 210 may correspond to a location of “unreliability” or “unpredictability” in agentic workflow 206. For example, a given branchpoint 210 may be placed before an LLM call, a sample from a distribution, and/or another portion of agentic workflow 206 that involves the generation of probabilistic, randomized, and/or nondeterministic output. Each branchpoint 210 may be added to program 200 by a user (e.g., a developer of program 200); by another program (e.g., an LLM, agent, and/or machine learning model that predicts locations of probabilistic output in logic code units 202); and/or based on rules, heuristics, and/or patterns associated with logic code units 202.

In some embodiments, generation engine 122 converts branchpoints 210 and/or other points in program 200 into nodes 222(1), 222(2)-222(A), 222(A+1)-222(B), 222(C)-222(D) (each of which is referred to individually herein as node 222) within a tree- or graph-based search space 220. For example, generation engine 122 may create, within search space 220, a root node 222(1) representing the start of program 200, one or more leaf nodes 222 representing the end of program 200 (e.g., as denoted by return statements and/or other indicators that the execution of agentic workflow 206 is complete), and one or more nodes 222 between the root node 222(1) and leaf nodes 222 that represent one or more branchpoints 210 specified in program 200.

Generation engine 122 also connects pairs of nodes 222 in search space 220 with edges 224(1)-224(A−1), 224(A)-224(B−1), 224(E)-224(F) (each of which is referred to individually herein as edge 224) representing transitions between corresponding points in agentic workflow 206. For example, each edge 224 may denote a probabilistic transition from a state 216(1)-216(Z) (each of which is referred to individually herein as state 216) at a starting point represented by a first node 222 at which that edge 224 originates to another state 216 at an ending point representing by a second node 222 at which that edge 224 terminates. Each state may include a set of variables mapped to a set of values at a corresponding point in program 200. Consequently, search space 220 may correspond to a Markov chain over the space of possible pairs of points and corresponding states 216 in program 200.

Additionally, edges 224 from a parent node 222 in search space 220 to a set of child nodes 222 may indicate a branching of the execution of program 200 into multiple branches of execution between a first point and corresponding state 216 represented by the parent node 222 and one or more subsequent points and corresponding states 216 represented by the child nodes 222. Each branch of execution may correspond to a different transition that is denoted by a starting state 216 at the first point and an ending state 216 at a subsequent point.

In one or more embodiments, generation engine 122 compiles program 200 into search space 220 for search by performing a partial conversion to continuation-passing style (CPS), in which control flow is explicitly defined in the form op (input, rest), where an operation op is applied to input and the result is passed to a function rest that represents the remainder of program 200. Within program 200, branchpoints 210 and/or control flow structures (e.g., loops, conditional statements, jump statements, etc.) that include branchpoints 210 can be converted into CPS.

An example program 200 with search code units 204 specifying a set of branchpoints 210 includes the following:

```
@encompass.compile
def statement_sequence(args):
  x1 = do_task1(args)
  branchpoint( )
  x2 = do_task2(x1)
  branchpoint( )
  x3 = do_task3(x2)
  return x3
```

This example program 200 includes an @encompass.compile function decorator that indicates that a statement_sequence function is to be compiled into a corresponding search space 220. The example program 200 also includes a linear control flow with logic code units 202 (e.g., x1=do_task1(args), x2=do_task2(x1), x3=do_task3(x2), etc.) interleaved with branchpoint( ) statements that specify locations of corresponding branchpoints 210 in program 200.

The example program 200 may be compiled into a corresponding search space 220 with the following representation:

```
def statement_sequence(frame, branchpoint_callback, return_callback):
  frame[“x1”] = do_task1(frame[“args”])
  def rest(frame, branchpoint_callback, return_callback):
    frame[“x2”] = do_task2(frame[“x1”])
    def rest(frame, branchpoint_callback, return_callback):
      frame[“x3”] = do_task3(frame[“x2”])
    return_callback(frame[“x3”])
    branchpoint_callback(frame, rest)
    branchpoint_callback(frame, rest)
```

In the above representation, each branchpoint( ) in program 200 is converted into a branchpoint_callback(frame, rest) that defines what to do when execution reaches a corresponding branchpoint 210 and a return_callback(rv) that defines what to do when execution of that branchpoint 210 returns. The compiled search space 220 takes as input an initial state 216 frame that includes input arguments into program 200, along with the branchpoint_callback and return_callback functions that define the behavior of branchpoints 210 and corresponding return statements.

After program 200 is compiled into search space 220, execution engine 124 executes agentic workflow 206 in a way that searches over possible paths 232 from the root node 222(1) to a set of leaf nodes 222 within search space 220. More specifically, execution engine 124 generates and executes separate sets of one or more branches 208(1)-208(Y) (each of which is referred to individually herein as branch 208) between successive branchpoints 210 and/or other points in program 200 (e.g., the start of program 200, the end of program 200, etc.) that are represented by nodes 222 connected by edges 224 in search space 220.

Each branch 208 corresponds to a different thread of execution that starts at a certain state 216 of a first branchpoint 210 (or another point in program 200) and ends at a second branchpoint 210 (or another point in program 200) and corresponding state 216. Each branch 208 may also, or instead, be associated with a corresponding score 214(1)-214(Y) (each of which is referred to individually herein as score 214) that is calculated based the starting state 216, ending state 216, and/or other values associated with that branch 208. As described in further detail below, scores 214 associated with branches 208 and/or a search policy 212 may be used to guide a search of search space 220 and generate a final output 234 of agentic workflow 206.

As branches 208 within agentic workflow 206 are executed, execution engine 124 populates a search tree 226 corresponding to search space 220 with scores 214, states 216, and/or other data associated with branches 208. Within search tree 226, nodes represent specific branchpoints 210 and/or other points in program 200 and the corresponding states 216. A directed edge between a first node and a second node in search tree 226 represents an executed branch 208 that transitions from a starting point and state 216 represented by the first node to an ending point and state 216 represented by the second node.

More specifically, execution engine 124 may initialize search tree 226 with a root node that corresponds to the root node 222(1) of search space 220 and represents the start point and corresponding start state 216 of agentic workflow 206. For each node in search tree 226, execution engine 124 may generate and execute one or more branches 208 from the start point and state 216 represented by that node to an ending point and state 216 within agentic workflow 206. After a given branch 208 is executed, execution engine 124 may add, to search tree 226, a directed edge from that node to a child node representing the ending point and state 216. Execution engine 124 may also store, in each node and/or in one or more data elements and/or data structures associated with each node, a corresponding point in program 200, a state at that point, and/or a numeric score 214 associated with a corresponding branch 208 that terminates at that node.

After execution of agentic workflow 206 is complete (e.g., after search tree 226 has been populated with one or more paths 232 from the start of program 200 to the end of program 200), execution engine 124 determines a final output 234 of agentic workflow 206 based on states 216, scores 214, and/or other attributes associated with branches 208 and/or points on paths 232. For example, execution engine 124 may choose final output 234 as the output of a final branch 208 that terminates at the end of program 200 and is associated with a highest score 214, an output that appears the most times in a set of final branches 208 that terminate at the end of program 200, and/or another state 216 and/or value that otherwise optimizes for one or more objectives associated with agentic workflow 206.

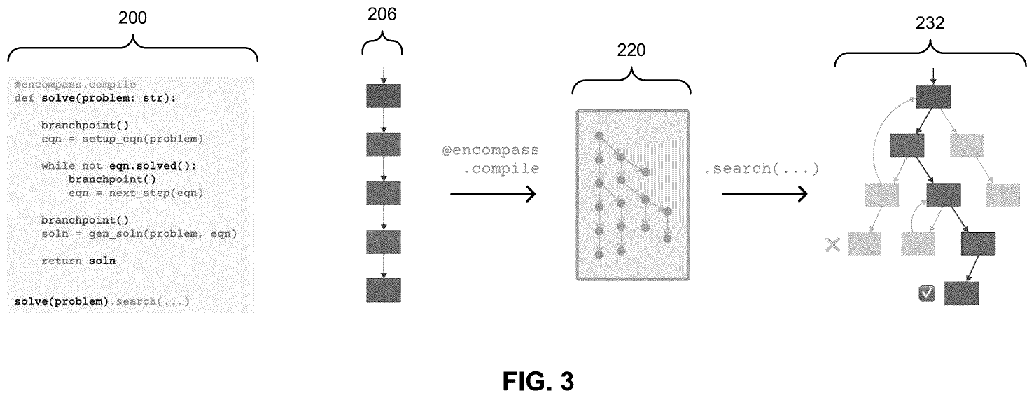

FIG. 3 illustrates the compilation and execution of an example agentic workflow 206 by generation engine 122 and execution engine 124 of FIG. 1, according to various embodiments. As shown in FIG. 3, agentic workflow 206 is defined by a corresponding program 200 that includes the @encompass.compile function decorator and a function named solve. This function includes three branchpoint( ) statements that place corresponding branchpoints 210 before three steps of writing out an equation for solving a problem passed in as a string, solving the equation by iteratively transforming the equation, and generating a solution to the problem.

This program 200 is compiled into an object that represents search space 220 over which various search strategies can be overlaid. A given search strategy can be used to generate a set of paths 232 that explore various sets of branches 208 between successive points (e.g., the beginning of program 200, the three branchpoints 210, the end of program 200) and corresponding states 216 within agentic workflow 206. Final output 234 of agentic workflow 206 may then be selected from a given path based on scores 214, states 216, and/or other attributes associated with branches 208 and/or paths 232 generated by the search strategy.

Returning to the discussion of FIG. 2, in some embodiments, execution engine 124 executes agentic workflow 206 based on a given search policy 212 associated with search space 220. Search policy 212 may include a search strategy (e.g., depth-first search, breadth-first search, best-first search, beam search, Monte Carlo tree search (MCTS), etc.) to be applied to branches 208 of agentic workflow 206. Search policy 212 may also, or instead, include a set of search parameters associated with the search strategy, such as (but not limited to) a branching factor, beam width, objective to be optimized (e.g., based on states 216 and/or scores 214 associated with branches), and/or other attributes that control and/or influence a selection 218 of one or more branchpoints 210 and corresponding states 216 at which a given set of branches 208 terminates as starting points for the next set of branches 208 to execute in agentic workflow 206.

Execution engine 124 also, or instead, executes agentic workflow 206 based on a set of calls 230(1)-230(X) (each of which is referred to individually herein as call 230) received over an interface 228 associated with search space 220 (e.g., after program 200 is compiled into search space 220). Each call 230 may be used to carry out and/or control an inference-time search strategy that is used to execute agentic workflow 206.

In one or more embodiments, search code units 204 include statements and/or primitives associated with inference-time search strategies involving branchpoints 210. For example, search code units 204 associated with a Python program 200 may include the following core primitives:
[symbol] [0049] branchpoint(**branchpoint_params): This statement marks the location of a given branchpoint 210 in program 200. A set of branchpoint_params can be used with the statement to provide search parameters related to an external search strategy, such as (but not limited to) a branching factor, beam width, and/or objective to be optimized.
[symbol] [0051] record_score(score): This statement records a numeric score 214 that can be used to guide the search process in various search strategies (e.g., the heuristic in best-first search and value function in MCTS). A final score 214 (e.g., the last score 214 recorded before returning from execution) may correspond to and/or may be used to compute a final evaluation score 214 that is the objective of a given search strategy.

When branchpoint statements are combined with proper verification from record_score statements (see below), execution of agentic workflow 206 may create the effect that the corresponding program has been executed without branchpoints, but the stochastic operations that follow the original branchpoints are now biased to more desirable outputs, and unreliable operations (e.g., LLM calls) have become more reliable. This effect, a form of angelic nondeterminism, is accomplished via search over nondeterministic branches 208 of the execution of program 200. More specifically, when the execution of program 200 reaches a given branchpoint 210, execution engine 124 causes program 200 to branch into multiple copies of itself and uses an external search policy 212 to search over branches 208 of program 200.

After a given function (or another portion of program 200) is decorated with search code units 204, a search over nondeterministic execution branches 208 and/or paths 232 may be performed via a search call 230 over a search space interface 228:
my_func( . . . ).search(policy, **search_config)
   In the above call, policy is a string that specifies search policy 212 to be used in the search and search_config includes search parameters to be used in the search.

An example usage of the above core primitives includes the following:

```
@encompass.compile
def branchpoint_example(...):
  branchpoint( )
  ... # Do something
  record_score(...)
# Sample 10 times and output the result with the highest score
branchpoint_example(...).search(“dfs”, default_branching=10)
```

In the above example, a branchpoint statement is added at the top of the function body, resulting in best-of-N sampling.

Search code units 204 associated with a Python program 200 may also, or instead, include a branchpoint_choose(choices: Iterable, **branchpoint_params) primitive, which is a variant of branchpoint where branches 208 evaluate to the elements in the Iterable, resulting in regular angelic nondeterminism. An example usage of this primitive includes a function that guesses a path from a start node to a goal in a graph:

```
@encompass.compile
def graph_search(graph, start_node, goal):
  “““
  Guess a path from ‘start_node’ to ‘goal’ in a ‘graph’ represented as an adjacency list.
  ”””
  cur_node = start_node
  path = [cur_node]
  cost_so_far
  while cur_node != goal:
    next_node = branchpoint_choose(graph[cur_node], identity=cur_node)
    path = path + [cur_node]
    cost_so_far += get_edge_cost(cur_node, next_node)
    total_estimated_cost cost_so_far + estimate_cost_to_go(next_node, goal)
    record_score(-total_estimated_cost)
    cur_node = next_node
return path
# Conduct best-first search −> shortest path with A* search
graph_search(my_graph, my_start_node, my_goal).search(“best_first”, top_k_popped=1,
default_branching=None)
```

In the above example, conducting search over the nondeterministic execution branches becomes equivalent to search over the graph.

Search code units 204 associated with a Python program 200 may also, or instead, include an early_stop_search( ) primitive that early-stops the external search process (e.g., because a correct and/or optimal final output 234 has been found). An example usage of this primitive includes a function that stops once a success condition is verified:

```
@encompass.compile
def early_stop_search_example(...):
  ... # Do something before
  branchpoint( )
  # Ask LLM to generate answer
  answer = llm.generate(...)
  # Check answer
  success = check_answer(answer)
  if success:
    early_stop_search( )
  return answer
```

Search code units 204 associated with a Python program 200 may also, or instead, include a delete_branch(err=None) primitive that deletes the current branch 208 of program execution. This primitive may be used, for example, to discontinue search based on the current branch 208 after an LLM call generates irreparably bad output:

```
@encompass.compile
def delete_branch_example(...):
  ... # Do something before
  branchpoint( )
  # Ask LLM to do something
  response = llm.generate(...)
  sanity_check_passed = sanity_check_llm_response(response)
  if not sanity_check_passed:
    delete_branch( )
  ... # Do something after
```

Search code units 204 associated with a Python program 200 may also, or instead, include an optional_return(return_value) primitive that signals to an external search process that, while program 200 execution hasn't finished, an output return_value has already been produced and should be treated as a possible final output 234 of program 200:

```
@encompass.compile
def optional_return_example(...):
  answer = llm.generate_answer(...)
  optional_return(answer)
  refined_answer = llm.refine_answer(answer, . . .)
  return refined_answer
```

Search code units 204 associated with a Python program 200 may also, or instead, include a protect (expr, exception) primitive that creates the effect that an expression that would raise an exception no longer raises the exception. This is accomplished by resampling from the most recent branchpoint 210 until evaluating the expression no longer raises the exception. An example usage of this primitive may include parsing the output of an LLM, which can be unreliable and/or result in errors:

```
@encompass.compile
def parse_llm_output_example(...):
  ... # Do something before
  branchpoint( )
  # Ask LLM to generate Python code
  response = llm.generate(...)
  # Extract Python code
  python_code = protect(response.split(“‘″’python\n”, 1)[1]
    .split(“6c′”, 1)[0], IndexError)
  # Parse Python code
  python_ast = protect(ast.parse(python_code), SyntaxError)
  ... # Do something after
```

Search code units 204 associated with a Python program 200 may also, or instead, include a record_costs(cost_name1=cost_amount1, cost_name2=cost_amount2, . . . ) primitive that can be used to track costs related to LLM usage and/or other types of overhead or resource consumption:

```
@encompass.compile
def record_costs_example(...):
  response, cost = llm.generate(...)
  record_costs(llm_cost=cost, llm_num_calls=1)
  return response
```

The recorded costs can be aggregated and accessed through a dictionary func.aggregate_costs (described in further detail below), where func is the compiled function.

Search code units 204 associated with a Python program 200 may also, or instead, include a record_score(multiple_evaluator, eval_target, label=eval_label) primitive that is an overloading of record_score and enables the computation of a certain score 214 based on a comparison of states 216 across multiple program 200 execution branches 208. One use case for this involves self-consistency majority voting, where evaluating a result is performed relative to all results.

Search code units 204 associated with a Python program 200 may also, or instead, include a searchover(func(*args, **kwargs)) primitive that is used to call a backbone func within another backbone:

```
@encompass.compile
def helper_function(...):
  ... # Do something
@encompass.compile
def searchover_example(...):
  ... # Do something before
  # Check answer
  helper_result = searchover(helper_function(...))
  ... # Do something after
```

This is similar to the use of await func ( . . . ) syntax to call an asynchronous function within an asynchronous function.

In some embodiments, interface 228 associated with search space 220 includes the following calls 230:
[symbol] [0066] func(*args, **kwargs).start( ): This begins execution of a function with the given arguments until the first branchpoint (e.g., a branchpoint( ) or branchpoint_choose( )), which can be inside a nested searchover( ) function call, is reached. A corresponding state 216 at that point is wrapped into a Checkpoint object, which can be used to step through the function and/or generate pairs of states 216 and branchpoints 210.
[symbol] [0068] func(*args, **kwargs).search(search_policy, **search_params)-> Any: This conducts search over the compiled search space 220 using the specified search policy 212 and returns a corresponding final output 234 that can include the return value (from either return return_value or optional_return (return_value)) from a certain branch 208 that terminates at the end point of program 200 with the highest recorded score 214.
[symbol] [0070] func.aggregate_costs: This is a dictionary containing the aggregate costs from all record_cost statements. A key of cost_name is mapped to the sum of all recorded costs with that name record_cost (cost_name= . . . ).
[symbol] [0072] func.branchpoint_step_counts: This is a dictionary that maps the name of a branchpoint to the number of times step( ) (described in further detail below) has been called on a checkpoint of that branchpoint, over all calls to func since the last time zero_branchpoint_counts( ) was called (see below). The dictionary will include step counts for branchpoints 210 with a name parameter (e.g., branchpoint(name= . . . ) or branchpoint_choose(choices, name= . . . )).
[symbol] [0074] func.zero_branchpoint_counts( ): This is a dictionary that zeros out the recorded total step counts of each named branchpoint 210.

In some embodiments, a given state 216 at a corresponding branchpoint 210 is stored in a Checkpoint object, which supports the following interface 228 calls 230:
[symbol] [0077] Checkpoint.step(max_protection=None, score_db_flush_queue=True)-> Checkpoint: This continues execution of program 200 starting from the stored state 216 at a given branchpoint 210 until the next branchpoint 210 is reached, returning a new Checkpoint object. Any expressions protected by a protect (expr, exception) trigger resampling whenever the exception occurs, up to a maximum of max_protection resamplings. If score_db_flush_queue is set to False, pending evaluations recorded through the multiple-evaluation version of record_score are not processed. Multiple step( ) calls on the same Checkpoint are mostly independent: while variable assignments are independent, variable references are shared, so that mutations to an object created before the current checkpoint are seen by all execution branches 208 descended from this checkpoint. If a given branchpoint 210 is a branchpoint_choose(choices: Iterable) instead of a regular branchpoint( ) statement, then multiple step( ) calls iterate through choices, and the resultant branches 208 evaluate to the elements in choices.
[symbol] [0079] Checkpoint.step_sampler (max_samples=None, max_protection=None, score_db_flush_queue=True)-> Generator [Checkpoint, None, None]: This calls step( ) repeatedly and generates the resultant Checkpoint objects. This is done for at most max_samples and/or until the list of choices has been exhausted in branchpoint_choose. Additionally, max_protection specifies the total number of resamplings allowed for protected expression evaluations.
[symbol] [0081] Checkpoint.parallel_step_sampler (max_samples=None, chunk_size=None, max_protection=None, max_workers=None, score_db_flush_queue=True)-> Generator[Checkpoint, None, None]: This is a multithreaded version of Checkpoint.step_sampler( ) where max_workers specifies the maximum number of threads to use and chunk_size, if given, performs parallel samplings in batches of that size.
[symbol] [0083] Checkpoint.status: Status: The status of the checkpoint object. One of Status.RUNNING, Status.DONE_STEPPING, Status.RETURNED, and Status.KILLED.
[symbol] [0085] Checkpoint.has_return_value: bool: Whether there's a return value from return return_value (if the checkpoint is at a return statement) or
   optional_return (return_value) (if the checkpoint is at a given branchpoint 210).
[symbol] [0088] Checkpoint.return_value: Any: The return value of the function if it exists (i.e., if the checkpoint is at a return statement, or it is at a branchpoint following an optional_return statement without an intervening branchpoint 210.
[symbol] [0090] Checkpoint.early_stopped_search: bool: Whether an early_stopped_search( ) statement has been called on any branch 208 of the execution of program 200.
[symbol] [0092] Checkpoint.score: The most recent recorded score 214 made through record_score.
[symbol] [0094] Checkpoint.branchpoint_params: dict: This is a dictionary containing the parameters of a given branchpoint 210 as specified through branchpoint(**branchpoint_params) or branchpoint_choose(choices, **branchpoint_params)).

In one or more embodiments, conversion of a function (or another portion of program 200) into CPS includes an initial syntax check to verify that search code units 204 are used correctly, followed by abstract syntax tree (AST) preprocessing that transforms variable accesses to explicit access to a dictionary holding a corresponding state 216 (e.g., x→frame[x]), tagging primitives and/or other search code units 204, and expanding nested calls to search code units 204 that are functions so that the functions are directly assigned to temporary variables (e.g., my_func (branchpoint_choose([0,1,2]))→tmp=branchpoint_choose([0,1,2]); my_func(tmp)). AST transformations of branchpoints 210 to CPS style are then performed by calling a branchpoint 210 callback function with the current state 216 frame and a continuation frame, along with additional arguments to convey further information. Similarly, return statements are transformed into calling a return callback function.

Subsequently, to create a checkpoint interface 228, the branchpoint callback registers the current state 216 frame as well as the rest function containing the rest of program 200 execution and returns a checkpoint object containing that state and rest function. A simplified implementation of the checkpoint interface 228 that supports only branchpoints 210 as primitives may include the following:

```
class Checkpoint:
  ... # Constructor omitted
  def step(self):
    new_checkpoint = Checkpoint( )
    def branchpoint_callback(frame, rest):
      new_checkpoint._frame = frame
      new_checkpoint._rest = rest
    def return_callback(rv):
      new_checkpoint._rv = rv
    self._rest(
      self.frame.copy( ),
      branchpoint_callback,
      return_callback,
    )
    return new_checkpoint
```

In the above checkpoint interface 228 implementation, the frame object is copied to keep different branches 208 from mutating the same frame object. Most other primitives provide auxiliary information in the form of additional arguments in the callback functions. The delete_branch( ) function requires return callback to be separated into two callback functions, in which return_callback is called when a given function with search code units 204 returns to another function with search code units 204 and finish_callback is called when a top-level function with search code units 204 returns and/or when delete_branch( ) is called in the top-level function or in a call to a different function with search code units 204.

As discussed above, search code units 204 can be placed in program 200 to implement best-of-N sampling on a global level (e.g., across the execution of agentic workflow 206). This can be extended to local best-of-N, where a multi-step agentic workflow 206 has best-of-N sampling applied to individual steps. This can be implemented by adding a different branchpoint 210 before each step and performing beam search with a beam width of 1:

```
@encompass.compile
def agent_forward(...):
  branchpoint( )
  ... # Step 1
  record_score(evaluate_step1(...))
  branchpoint( )
  ... # Step 2
  record_score(evaluate_step2(...))
  branchpoint( )
  ... # Step k
  record_score(evaluate_stepk(...))
  return stepk_result
N = ... # the “N” in best-of-N
result = agent_forward(...).search(“beam”, beam_width=1,
default_branching=N)
```

Because global best-of-N sampling corresponds to beam search with beam width N and branching factor 1 and local best-of-N sampling corresponds to beam search with beam width 1 and branching factor N, general beam search can be viewed as interpolating between global and local resampling. This interpolation effectively constrains search space 220 with local verification without losing global variety. Increasing the branching factor allows each step to be completed correctly and avoid compounding errors, while increasing the beam width can increase variety and/or improve reliability, thereby mitigating potential errors made in earlier steps.

Search code units 204 can also be used to implement refinement, in which sampling is performed with additional feedback from past sampling attempts. This can be accomplished by adding a given branchpoint 210 to generate multiple samples with a memory of past attempts shared across the sampled branches 208:

```
@encompass.compile
def agent_forward(...):
  ... # Code that comes before
  # Step with refinement
  feedbacks = [ ]
  branchpoint(branching=n_refine + 1)
  result = do_step(..., feedbacks)
  score, feedback = get_score_and_feedback(result)
  feedbacks.append(feedback)
  record_score(score)
  ... # Code that comes after
result = agent_forward(...).search(“beam”, beam_width=1)
```

More specifically, different branches 208 share the same reference to the feedbacks variable, so that appended feedback is seen by all branches 208.

Another branchpoint 210 can be added immediately before the feedbacks variable defined above to create multiple parallel refinement loops, thus interpolating between fresh sampling and refinement and increasing variety over an agentic workflow that focuses too much on past feedback. Additionally, backtracking with memory, in which execution backtracks to a previous step (e.g., branchpoint 210) with a memory of previous attempts, can be performed by creating a mutable data structure before a given branchpoint 210 so that the data structure acts as a memory that is shared across all subsequent branches 208.

Further, search code units 204 can be used to implement self-consistency, which samples N times and chooses an output that appears the most (e.g., the majority vote), by performing best-of-N sampling with an evaluation function that evaluates multiple results at the same time. This can be accomplished using the overloaded record_score( ) primitive:

```
def majority_vote(results):
  counts = defaultdict(int)
  for result in results:
    counts[result] += 1
  return [
    counts[result] for result in results
  ]
@encompass.compile
def agent_forward(...):
  branchpoint( )
  record_score(majority_vote, result, label=None)
  return result
result = agent_forward(...).search(...)
```

In general, allowing the evaluation function to evaluate multiple results at once can be helpful when it is difficult to evaluate a single result by itself. Another example of this involves evaluating multiple LLM-generated code samples against multiple LLM-generated unit test cases based on both the number of unit tests passed and agreement among code samples on which tests were passed.

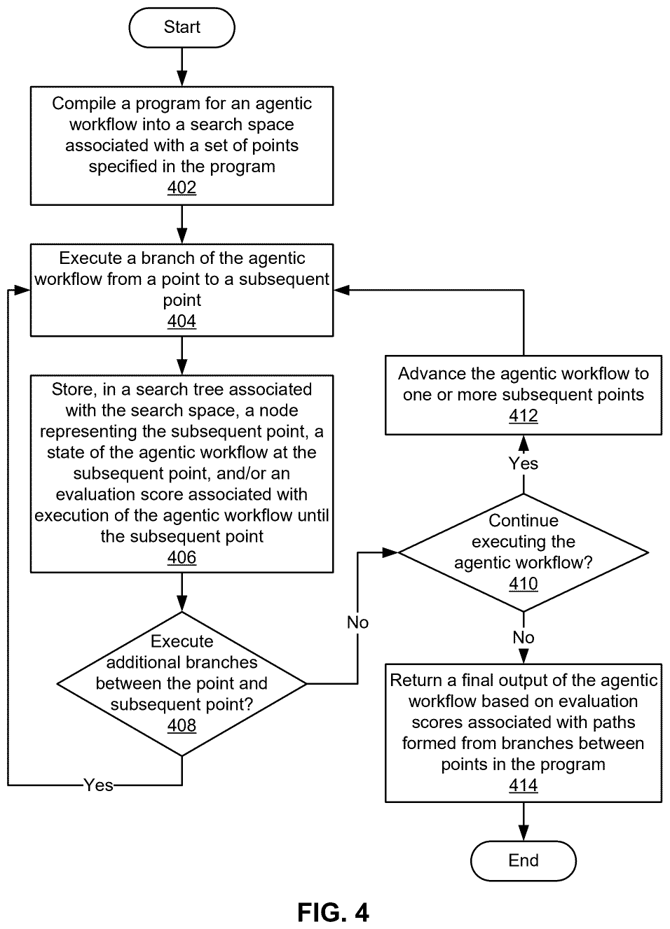

FIG. 4 is a flow diagram of method steps for generating and executing an agentic workflow, according to various embodiments. Although the method steps are described in conjunction with the systems of FIGS. 1-2, persons skilled in the art will understand that any system configured to perform the method steps in any order falls within the scope of the present disclosure.

As shown, in step 402, generation engine 122 compiles a program for an agentic workflow into a search space associated with a set of points specified in the program. For example, generation engine 122 may convert primitives, statements, and/or other search code units in source code for the program into CPS.

In step 404, execution engine 124 executes a branch of the agentic workflow from a point to a subsequent point. For example, execution engine 124 may initially execute a branch that starts at the beginning of the program and ends at the first branchpoint in the program. Execution engine 124 may also initialize a search tree associated with the search space with a root node that represents the beginning of the program and a state associated with the beginning of the program.

In step 406, execution engine 124 stores, in a search tree associated with the search space, a node representing the subsequent point, a state of the agentic workflow at the subsequent point, and/or an evaluation score associated with execution of the agentic workflow until the subsequent point. For example, execution engine 124 may add a child node to the search tree that represents the ending point and state of the executed branch, along with any score that was recorded during execution of that branch.

In step 408, execution engine 124 determines whether or not to execute additional branches between the point and the subsequent point. This determination may be based on a branching factor that specifies the number of branches to explore from a given starting point and/or other search parameters that control the exploration of the search space.

If execution engine 124 determines that additional branches are to be executed, execution engine 124 repeats step 404 to execute another branch from the same starting point and state to the subsequent point. Execution engine 124 also repeats step 408 to determine whether or not additional branches are to be executed.

When execution engine 124 determines that no additional branches are to be executed from the current point, execution engine 124 performs step 410 to determine whether or not to continue executing the agentic workflow. For example, execution engine 124 may determine that execution of the agentic workflow is to continue while the search space includes unexplored nodes, the end of the program has not been reached, and/or another termination condition (e.g., a maximum number of branches and/or paths have been explored, a time limit has been reached, etc.) has not been met.

If execution engine 124 determines that execution of the agentic workflow is to continue, execution engine 124 performs step 412 to advance the agentic workflow to one or more subsequent points. For example, execution engine 124 may select the subsequent point(s) as one or more nodes from the search tree with the highest scores 214 and/or based on other criteria specified in a search policy and/or search parameters associated with the agentic workflow. Execution engine 124 may then repeat steps 404, 406, 408, and 410 recursively to execute additional sets of branches from each selected point to one or more additional subsequent points in the program, determine whether or not to continue executing the agentic workflow, and/or advance the agentic workflow to some or all of the additional subsequent points.

If execution engine 124 determines in step 410 that execution of the agentic workflow is to be discontinued, execution engine 124 performs step 414 to return a final output of the agentic workflow based on evaluation scores associated with paths formed from branches between points in the program. For example, execution engine 124 may select the final output from the outputs of branches that terminate at the end of the program based on the associated scores, states, and/or other or other optimization criteria or objectives specified in the search policy and/or search parameters.

In sum, the disclosed techniques perform agentic workflow programming with search over execution branches, in which a program for an agentic workflow is compiled and run in a way that separates the logic for the agentic workflow from search strategies used to improve the performance and/or reliability of the agentic workflow. The agentic workflow may involve a multi-step process that includes invocations of large language models (LLMs) and/or other machine learning components that generate output probabilistically, tool usage, reasoning changes, code generation and/or execution, and/or other operations that can lead to variable and/or unreliable outputs.

More specifically, the disclosed techniques provide a probabilistic angelic nondeterminism (PAN) framework that allows source code for the agentic workflow to disentangle statements and/or calls related to an inference-time search strategy from the underlying logic of the agentic workflow. These statements and/or calls may specify branchpoints at which execution of the agentic workflow can be branched into multiple “threads” of execution.

During execution of the agentic workflow, each branch off of a corresponding branchpoint is executed until a subsequent branchpoint and/or another terminating point specified in the source code is reached. A state of the agentic workflow at the terminating point of each branch and/or an evaluation score associated with the branch are stored, and a search over execution paths composed of sequences of branches that span the agentic workflow is performed based on the corresponding states and/or evaluation scores. Search parameters and/or strategies used to perform the search can additionally be specified via calls over an interface provided by the framework. The process is recursively repeated for each path until the end of the program is reached. A final state and/or output of the agentic workflow may then be determined and/or outputted based on an objective associated with a “final evaluation score” and/or another attribute at the end of each path.

One technical advantage of the disclosed techniques relative to the prior art is the disentanglement of (i) source code, executable code, and/or other representations of logic for the agentic workflow from ((ii) corresponding representations of inference-time search strategies that can be used to improve the reliability and/or performance of the agentic workflow. The disclosed techniques thus reduce time and resource overhead associated with implementing, modifying, customizing, and/or transferring inference-time search strategies over conventional implementations of inference-time search strategies that apply, compile, and run a different set of modifications to source code for each agentic workflow. Additionally, the improved speed and efficiency with which inference-time search strategies can be explored and/or optimized may increase the reliability and/or performance of the agentic workflow over agentic workflows that are executed using conventional implementations of inference-time search strategies. Further, because the disclosed techniques allow inference-time search strategies to be defined using a basic set of statements and calls and/or without explicitly defining search spaces for agentic workflows, the disclosed techniques allow agentic workflows and inference-time search strategies of arbitrary complexity to be used with one another. These technical advantages provide one or more technological improvements over prior art approaches.

1. In some embodiments, a computer-implemented method for executing an agentic workflow comprises upon determining that a first branchpoint is reached during execution of the agentic workflow, executing, based on one or more calls received over an interface associated with the first branchpoint, a first plurality of branches from the first branchpoint and a state of the agentic workflow at the first branchpoint to one or more subsequent branchpoints within the agentic workflow; and executing, based on a first plurality of evaluation scores associated with executing the first plurality of branches, a second plurality of branches from at least a portion of the one or more subsequent branchpoints to one or more additional points within the agentic workflow.

2. The computer-implemented method of clause 1, further comprising determining a final output of the agentic workflow based on a second plurality of evaluation scores associated with executing the second plurality of branches.

3. The computer-implemented method of any of clauses 1-2, wherein determining the final output comprises determining that a point at which a branch included in the second plurality of branches terminates corresponds to an endpoint in the agentic workflow; and determining the final output based on a subsequent state of the agentic workflow at the point.

4. The computer-implemented method of any of clauses 1-3, further comprising compiling a program for the agentic workflow into a search space that includes the first branchpoint, the one or more subsequent branchpoints, and the one or more additional points, wherein the first plurality of branches and the second plurality of branches are executed based on a search of the search space.

5. The computer-implemented method of any of clauses 1-4, wherein the program for the agentic workflow specifies a first set of locations of the first branchpoint, the one or more subsequent branchpoints, and the one or more additional points; and a second set of locations at which the first plurality of evaluation scores are recorded.

6. The computer-implemented method of any of clauses 1-5, wherein the search of the search space is performed based on a search policy associated with the agentic workflow.

7. The computer-implemented method of any of clauses 1-6, wherein the one or more calls are associated with at least one of searching over the first plurality of branches and the second plurality of branches; a set of costs associated with the first plurality of branches and the second plurality of branches; and a number of branches included in the first plurality of branches.

8. The computer-implemented method of any of clauses 1-7, further comprising storing, in a search tree associated with the agentic workflow a first node representing the first branchpoint and a first state of the agentic workflow at the first branchpoint; and a plurality of nodes that are children of the first node, wherein each of the plurality of nodes represents (i) a branchpoint included in the one or more subsequent branchpoints and (ii) a state of the agentic workflow after a corresponding execution branch that is included in the first plurality of branches has terminated at the branchpoint.

9. The computer-implemented method of any of clauses 1-8, wherein the first plurality of branches is executed based on at least one of a branching factor associated with the first branchpoint or a beam width associated with the first branchpoint.

10. The computer-implemented method of any of clauses 1-9, wherein the state of the agentic workflow comprises at least one of a set of variables, a set of values for the set of variables, or a final output of the agentic workflow.

11. In some embodiments, one or more non-transitory computer-readable media store instructions that, when executed by one or more processors, cause the one or more processors to perform the steps of upon determining that a first branchpoint is reached during execution of an agentic workflow, executing, based on one or more calls received over an interface associated with the first branchpoint, a first plurality of branches from the first branchpoint and a state of the agentic workflow at the first branchpoint to one or more subsequent branchpoints within the agentic workflow; and executing, based on a first plurality of evaluation scores associated with executing the first plurality of branches, a second plurality of branches from at least a portion of the one or more subsequent branchpoints to one or more additional points within the agentic workflow.

12. The one or more non-transitory computer-readable media of clause 11, wherein the instructions further cause the one or more processors to perform the step of determining a final output of the agentic workflow based on a second plurality of evaluation scores associated with executing the second plurality of branches.

13. The one or more non-transitory computer-readable media of any of clauses 11-12, wherein determining the final output comprises determining that a second branchpoint at which an execution branch included in the second plurality of branches terminates (i) corresponds to an endpoint in the agentic workflow and (ii) is associated with a highest score included in the second plurality of evaluation scores; and determining the final output based on a third state of the agentic workflow at the second branchpoint.

14. The one or more non-transitory computer-readable media of any of clauses 11-13, wherein executing the first plurality of branches comprises generating, based on the state of the agentic workflow at the first branchpoint, a plurality of execution threads corresponding to the first plurality of branches; and executing each execution thread in the plurality of execution threads until a corresponding branchpoint included in the one or more subsequent branchpoints is reached.

15. The one or more non-transitory computer-readable media of any of clauses 11-14, wherein executing the first plurality of branches comprises performing a search of a search space that includes the first branchpoint and the one or more subsequent branchpoints based on one or more search parameters associated with the first branchpoint.

16. The one or more non-transitory computer-readable media of any of clauses 11-15, wherein the one or more search parameters comprise at least one of a branching factor or a beam width.

17. The one or more non-transitory computer-readable media of any of clauses 11-16, wherein each execution branch included in the first plurality of branches comprises an invocation of a language model.

18. The one or more non-transitory computer-readable media of any of clauses 11-17, wherein the one or more calls are associated with at least one of executing one or more branches included in the first plurality of branches; determining the state of the agentic workflow at the first branchpoint; or searching over the first plurality of branches.

19. The one or more non-transitory computer-readable media of any of clauses 11-18, wherein the first plurality of evaluation scores is computed based on at least one of an objective associated with the agentic workflow, a reinforcement learning reward, or a final output of the agentic workflow.

20. In some embodiments, a system comprises one or more memories that store instructions, and one or more processors that are coupled to the one or more memories and, when executing the instructions, are configured to perform the steps of upon determining that a first branchpoint is reached during execution of an agentic workflow, executing, based on one or more calls received over an interface associated with the first branchpoint, a first plurality of branches from the first branchpoint and a state of the agentic workflow at the first branchpoint to one or more subsequent branchpoints within the agentic workflow; and executing, based on a first plurality of evaluation scores associated with executing the first plurality of branches, a second plurality of branches from at least a portion of the one or more subsequent branchpoints to one or more additional points within the agentic workflow.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for executing an agentic workflow, the method comprising:
upon determining that a first branchpoint is reached during execution of the agentic workflow, executing, based on one or more calls received over an interface associated with the first branchpoint, a first plurality of branches from the first branchpoint and a state of the agentic workflow at the first branchpoint to one or more subsequent branchpoints within the agentic workflow; and
executing, based on a first plurality of evaluation scores associated with executing the first plurality of branches, a second plurality of branches from at least a portion of the one or more subsequent branchpoints to one or more additional points within the agentic workflow.

2. The computer-implemented method of claim 1, further comprising determining a final output of the agentic workflow based on a second plurality of evaluation scores associated with executing the second plurality of branches.

3. The computer-implemented method of claim 2, wherein determining the final output comprises:
determining that a point at which a branch included in the second plurality of branches terminates corresponds to an endpoint in the agentic workflow; and
determining the final output based on a subsequent state of the agentic workflow at the point.

4. The computer-implemented method of claim 1, further comprising compiling a program for the agentic workflow into a search space that includes the first branchpoint, the one or more subsequent branchpoints, and the one or more additional points, wherein the first plurality of branches and the second plurality of branches are executed based on a search of the search space.

5. The computer-implemented method of claim 4, wherein the program for the agentic workflow specifies:
a first set of locations of the first branchpoint, the one or more subsequent branchpoints, and the one or more additional points; and
a second set of locations at which the first plurality of evaluation scores are recorded.

6. The computer-implemented method of claim 4, wherein the search of the search space is performed based on a search policy associated with the agentic workflow.

7. The computer-implemented method of claim 1, wherein the one or more calls are associated with at least one of:
searching over the first plurality of branches and the second plurality of branches;
a set of costs associated with the first plurality of branches and the second plurality of branches; and
a number of branches included in the first plurality of branches.

8. The computer-implemented method of claim 1, further comprising storing, in a search tree associated with the agentic workflow:
a first node representing the first branchpoint and a first state of the agentic workflow at the first branchpoint; and
a plurality of nodes that are children of the first node, wherein each of the plurality of nodes represents (i) a branchpoint included in the one or more subsequent branchpoints and (ii) a state of the agentic workflow after a corresponding execution branch that is included in the first plurality of branches has terminated at the branchpoint.

9. The computer-implemented method of claim 1, wherein the first plurality of branches is executed based on at least one of a branching factor associated with the first branchpoint or a beam width associated with the first branchpoint.

10. The computer-implemented method of claim 1, wherein the state of the agentic workflow comprises at least one of a set of variables, a set of values for the set of variables, or a final output of the agentic workflow.

11. One or more non-transitory computer-readable media storing instructions that, when executed by one or more processors, cause the one or more processors to perform the steps of:
upon determining that a first branchpoint is reached during execution of an agentic workflow, executing, based on one or more calls received over an interface associated with the first branchpoint, a first plurality of branches from the first branchpoint and a state of the agentic workflow at the first branchpoint to one or more subsequent branchpoints within the agentic workflow; and
executing, based on a first plurality of evaluation scores associated with executing the first plurality of branches, a second plurality of branches from at least a portion of the one or more subsequent branchpoints to one or more additional points within the agentic workflow.

12. The one or more non-transitory computer-readable media of claim 11, wherein the instructions further cause the one or more processors to perform the step of determining a final output of the agentic workflow based on a second plurality of evaluation scores associated with executing the second plurality of branches.

13. The one or more non-transitory computer-readable media of claim 12, wherein determining the final output comprises:
determining that a second branchpoint at which an execution branch included in the second plurality of branches terminates (i) corresponds to an endpoint in the agentic workflow and (ii) is associated with a highest score included in the second plurality of evaluation scores; and
determining the final output based on a third state of the agentic workflow at the second branchpoint.

14. The one or more non-transitory computer-readable media of claim 11, wherein executing the first plurality of branches comprises:
generating, based on the state of the agentic workflow at the first branchpoint, a plurality of execution threads corresponding to the first plurality of branches; and
executing each execution thread in the plurality of execution threads until a corresponding branchpoint included in the one or more subsequent branchpoints is reached.

15. The one or more non-transitory computer-readable media of claim 11, wherein executing the first plurality of branches comprises performing a search of a search space that includes the first branchpoint and the one or more subsequent branchpoints based on one or more search parameters associated with the first branchpoint.

16. The one or more non-transitory computer-readable media of claim 15, wherein the one or more search parameters comprise at least one of a branching factor or a beam width.

17. The one or more non-transitory computer-readable media of claim 11, wherein each execution branch included in the first plurality of branches comprises an invocation of a language model.

18. The one or more non-transitory computer-readable media of claim 11, wherein the one or more calls are associated with at least one of:
executing one or more branches included in the first plurality of branches;
determining the state of the agentic workflow at the first branchpoint; or
searching over the first plurality of branches.

19. The one or more non-transitory computer-readable media of claim 11, wherein the first plurality of evaluation scores is computed based on at least one of an objective associated with the agentic workflow, a reinforcement learning reward, or a final output of the agentic workflow.

20. A system, comprising:
one or more memories that store instructions, and
one or more processors that are coupled to the one or more memories and, when executing the instructions, are configured to perform the steps of:
upon determining that a first branchpoint is reached during execution of an agentic workflow, executing, based on one or more calls received over an interface associated with the first branchpoint, a first plurality of branches from the first branchpoint and a state of the agentic workflow at the first branchpoint to one or more subsequent branchpoints within the agentic workflow; and
executing, based on a first plurality of evaluation scores associated with executing the first plurality of branches, a second plurality of branches from at least a portion of the one or more subsequent branchpoints to one or more additional points within the agentic workflow.
